(19) United States
(12) Patent Application Publication
(10) Pub. No.: US 2015/0112777 A1
(43) Pub. Date: Apr. 23, 2015

(54) MARKETPLACE SYSTEM

(71) Applicant: C.it Solutions, Inc., Brighton, MA (US)

(72) Inventor: Christopher Michael Turney, Aliso Viejo, CA (US)

(21) Appl. No.: 14/058,998

(22) Filed: Oct. 21, 2013

(51) Int. Cl. G06Q 30/02

(52) U.S. Cl. CPC G06Q 30/0213
USPC 705/14.15

(57) ABSTRACT

A method includes receiving a request for a pass of a type of pass from a first customer. The method includes, based on an availability of a pass of the requested type, enabling the first customer to purchase the pass of the requested type either (i) from a set of available passes of the requested type or (ii) from a second customer. The method includes enabling a mobile device associated with the first customer to be used to present the purchased pass.

### BACKGROUND

Marketing promotions, such as discounts, rebates, customer loyalty programs, and other types of promotions, can be used to increase customer loyalty and drive business at a retail establishment. For instance, a customer loyalty program that rewards a customer with a free coffee after purchasing ten coffee drinks at a particular business can encourage the customer to frequently patronize the business.

### SUMMARY

Among other things, in some implementations of what we describe, a marketplace system provides customers with access to a limited number of passes to a business. A pass provides its holder with access to free or discounted goods or services (which we sometimes refer to as a “pass item”) for a period of time (e.g., a month). For instance, a monthly soft drink pass to a sandwich shop can provide its holder with free soft drinks for each month the holder purchases the pass. Through the marketplace system, customers can, for example, purchase passes directly from the marketplace system, join a wait-list for an unavailable pass, or bid to purchase a pass from an existing pass holder.

In a general aspect, a method includes receiving a request for a pass of a type of pass from a first customer. The method includes, based on an availability of a pass of the requested type, enabling the first customer to purchase the pass of the requested type either (i) from a set of available passes of the requested type or (ii) from a second customer. The method includes enabling a mobile device associated with the first customer to be used to present the purchased pass.

Embodiments may include one or more of the following features.

The method includes determining the availability of the pass of the requested type. In some cases, determining the availability of the pass of the requested type includes determining how many of the requested type of passes have been purchased.

The method includes enabling the first customer to purchase a pass when at least one pass of the requested type is available.

The method includes enabling the first customer to purchase a pass from a second customer when no pass of the requested type is available.

Enabling the first customer to purchase a pass from the second customer comprises receiving a bid from the first customer for the pass. In some cases, enabling the first customer to purchase the pass from the second customer includes providing a notification of the bid to one or more second customers; and receiving an acceptance from one of the second customers. In some cases, the method includes prompting the first customer to provide a bid for the pass. In some cases, enabling the first customer to purchase the pass from the second customer includes notifying the first customer that the second customer is selling a pass of the requested type; and receiving the bid responsive to the notifying. In some cases, the method includes receiving an offer to sell the pass from the second customer.

The method includes associating the first customer with a wait-list for the requested type of pass if the requested type of pass is not available. In some cases, the method includes enabling the first customer to purchase a pass from a set of available passes of the requested type based on the availability of a pass of the requested type and a position of the first customer on the wait-list. In some cases, the method includes updating a position of the first customer on the wait-list based on a purchase of a pass of the requested type by a third customer.

Enabling the mobile device to be used to present the purchased pass comprises providing a pass token associated with the purchased pass to the mobile device. In some cases, providing the purchased pass to the mobile device includes providing at least one of an identifier of a business associated with the pass, an identifier of a pass item associated with the pass, a date associated with the pass, and an identifier of the first customer.

In a general aspect, a computer readable storage medium stores instructions for causing a computing system to receive a request for a pass of a type of pass from a first customer. The instructions cause the computing system to, based on an availability of a pass of the requested type, enable the first customer to purchase the pass of the requested type either (i) from a set of available passes of the requested type or (ii) from a second customer. The instructions cause the computing system to enable a mobile device associated with the first customer to be used to present the purchased pass.

In a general aspect, a method includes receiving a notification of an opportunity to purchase a pass of a requested type of pass either (i) from a set of available passes of the requested type, or (ii) from a customer; sending instructions to purchase the pass of the requested type; and receiving data associated with the purchased pass.

Embodiments can include one or more of the following features.

The method includes sending a request for the pass of the requested type.

Sending instructions to purchase the pass comprises specifying a bid amount.

The data associated with the purchased pass comprises one or more of an identifier of a business associated with the pass, an identifier of a pass item associated with the pass, a date associated with the pass, and an identifier of the purchaser of the pass

In a general aspect, a method includes displaying to a business, on a display interface of a mobile device, data indicative of a pass item associated with a purchased pass of a particular type. The pass is purchased either (i) from a set of available passes of the particular type, or (ii) from a customer.

These and other aspects, features, and implementations, and combinations of them, can be expressed as methods, apparatus, systems, components, software products, business methods, means and steps for performing functions, and in other ways. Other features and advantages will be apparent from the following description and from the claims.

### DESCRIPTION

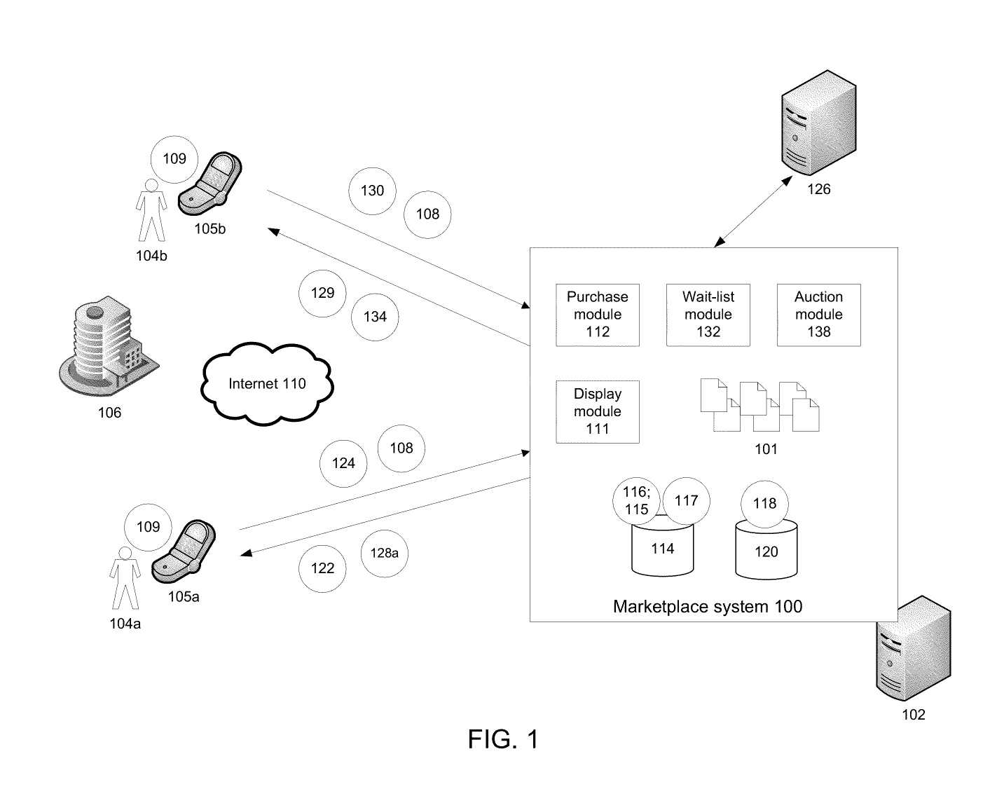

FIGS. 1-3 are system diagrams.

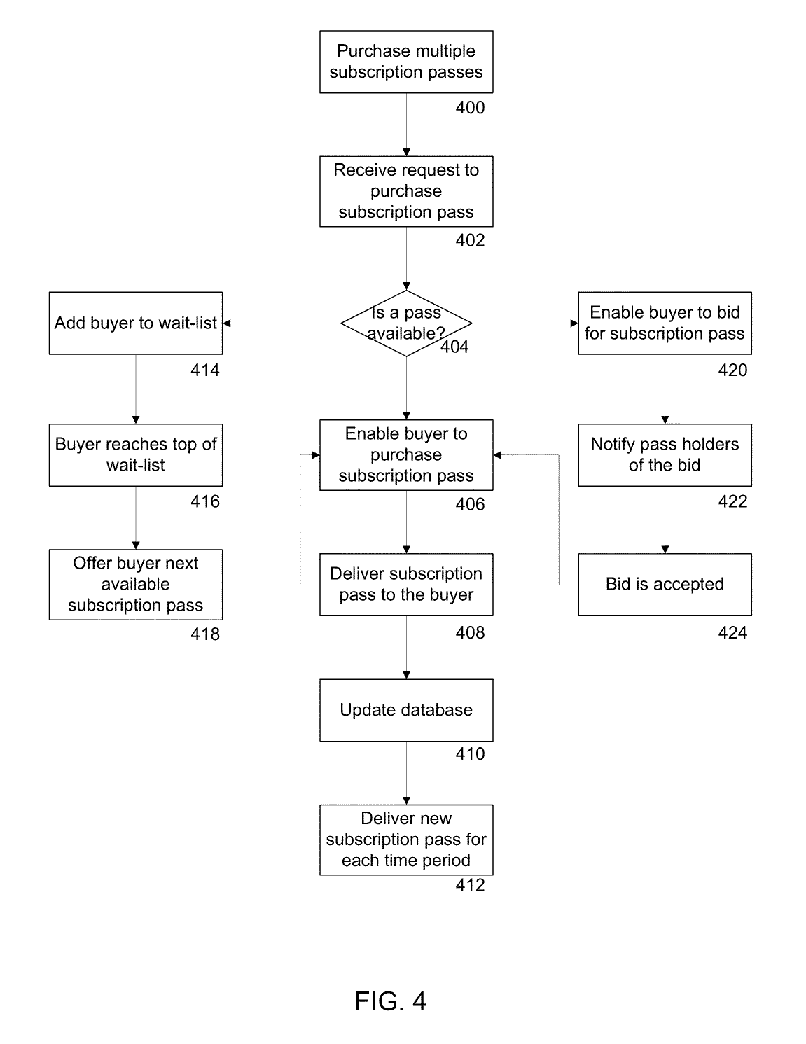

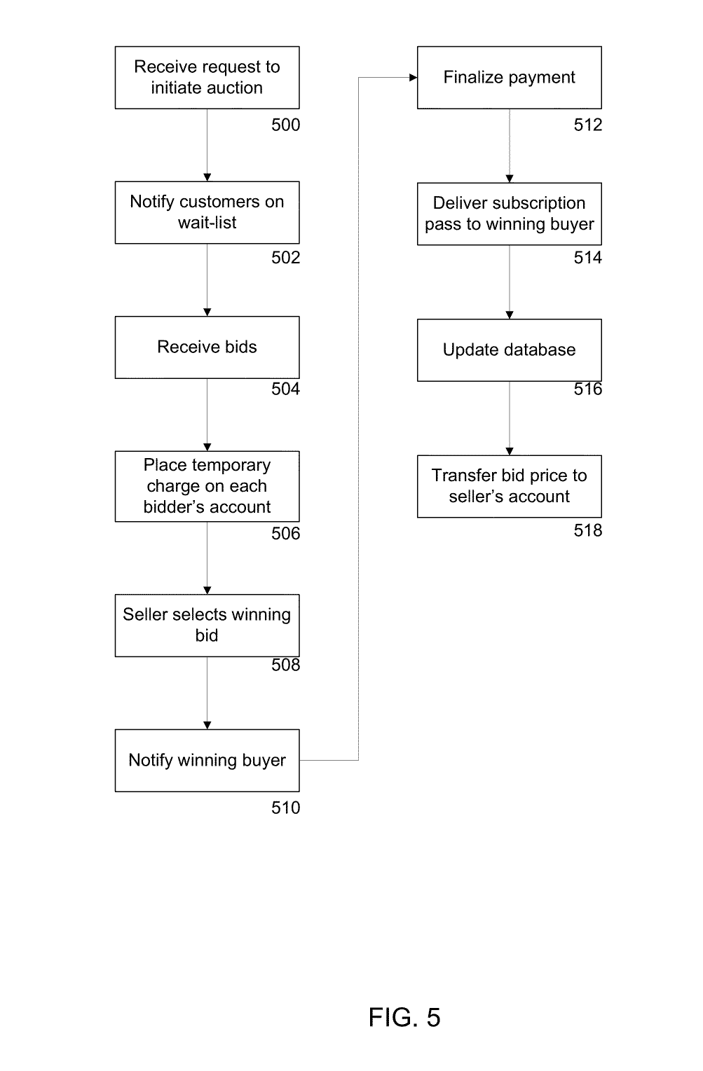

FIGS. 4 and 5 are flow charts.

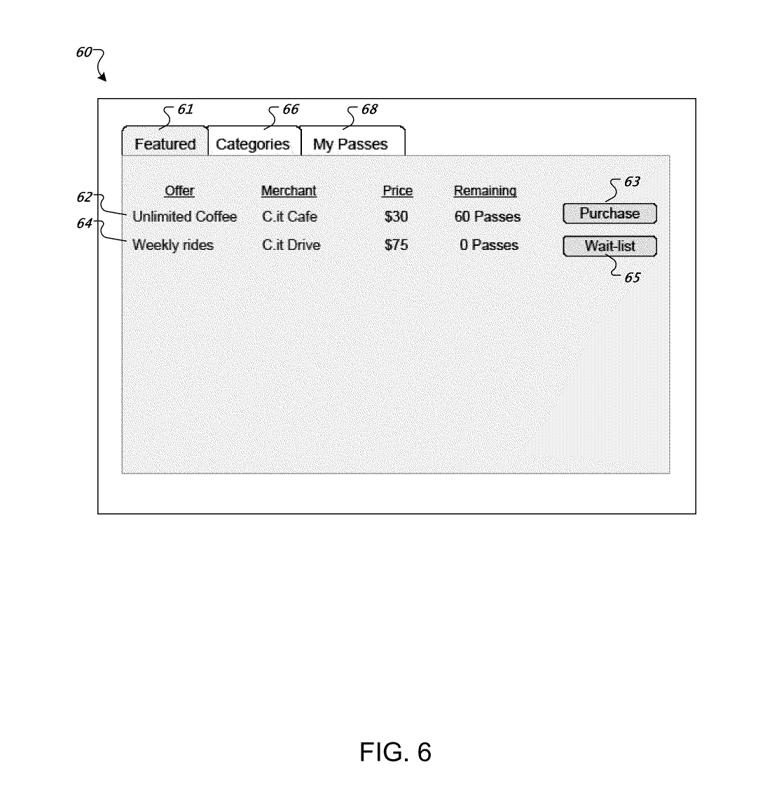

FIGS. 6-11 are screenshots.

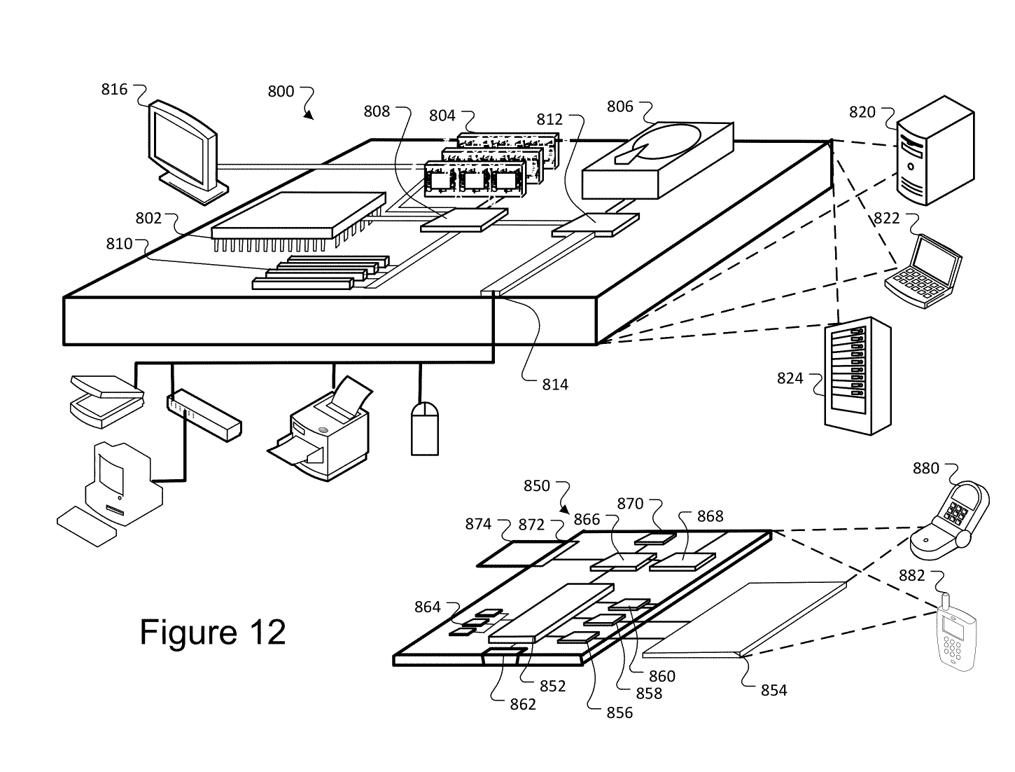

FIG. 12 is a system diagram.

We describe here a marketplace system that provides customers and potential customers of a business with access to passes (for example, a limited number of passes) to engage in transactions with the business. A subscription pass provides its holder with a right to engage in transactions on more favorable terms than other customers of the business, for example, access to free or discounted goods or services (the “pass item”). The pass typically provides that right only for a limited and specified period of time (e.g., a month). For instance, a month pass to a sandwich shop can provide its holder with free soft drinks for the month specified by the terms of the pass. In some implementations of the system we describe here, the pass is one of a series of passes acquired by a buyer as part of a subscription, which we sometimes call a pass subscription. We sometimes call each of the passes that are part of a pass subscription, a subscription pass. Through the marketplace system, customers can purchase pass subscriptions, and hence the passes that make up the pass subscription, directly from the marketplace system, or they can join a wait-list for an unavailable pass, or they can bid on a pass from an existing pass holder, among other things.

In some implementations, the number of passes issued for a given period, or the number of pass subscriptions offered is limited. By offering only a limited number of passes or pass subscriptions to a given business, the marketplace system can help to build customer loyalty among a small group of committed customers, can reduce the total cost of the loyalty program to a manageable level rather than risking a high and uncontrolled cost, and can drive a more active business environment for the business. For instance, a customer holding a pass for a particular business may frequent that business often and may purchase additional items beyond the pass item associated with the pass. For instance, a customer holding a monthly pass for free coffee at a deli may also purchase a sandwich or a cookie. In addition, because a customer holding a pass for a particular business has a reason to frequent that business, he may encourage his friends to accompany him, thus driving up the revenue and increasing the visibility of the business. In other words, many of the positive aspects of a loyalty system are true of the system that we are describing.

Because the marketplace system handles the distribution of passes for a business to its customers, the business can avoid the financial risk associated with giving away free pass items (e.g., giving away a large number of pass items). For instance, in some examples, the marketplace system pays an upfront lump sum of money to purchase a set number of passes from a business, thus helping to provide financial security to the business and reducing the risk to which the business is exposed. In some examples, the marketplace system will process the customer's payments and provide those payments directly to the business, thus helping the business to reduce the overhead associated with administering a pass program.

Referring to FIG. 1, a marketplace system 100 hosted on one or more servers 102 provides a marketplace for customers 104 to purchase, sell, and transfer passes 101 for one or more businesses 106, such as restaurants, retail stores, service providers, or other types of businesses, or a combination of any two or more of them. A pass 101 provides its holder with a right to engage in transactions with a business on more favorable terms than other customers of the business, for example, by having access to free or discounted goods or services (the “pass item”) for a period of time (e.g., on a monthly basis). In some examples, a customer can purchase an ongoing pass subscription that is renewed for each subsequent time period (e.g., a pass subscription for a monthly pass that is renewed each month). In some examples, some or all of the passes 101 need not be sold as part of a subscription, but can be sold individually. In one example, a pass subscription for a monthly pass to a Laundromat can provide a holder of the pass with a month's worth of free use of the dryers at the Laundromat for as long as the holder continues his pass subscription. In one example, a yearly pass to a bookstore can provide a holder of the pass with a 50% discount on any magazine purchase during the year.

Only a limited number of passes 101 for each business 106 are available for purchase. The number of available passes can be determined by the business, by the marketplace system, or by a negotiation between them. We sometimes refer to a set of pass subscriptions that are associated with a particular pass item and a particular pass for a particular business as a pass series. Once all of the passes or pass subscriptions of a particular series have been purchased, no more passes or pass subscriptions of that series are available for original purchase from the marketplace system 100. For instance, the marketplace system 100 can administer a pass series including 100 monthly pass subscriptions for unlimited coffee at Jake's Deli. Once all of the 100 monthly pass subscriptions of that series have been sold to customers 104, no additional pass subscriptions for unlimited coffee Jake's Deli are available for purchase directly from the marketplace system 100. However, customers interested in purchasing an individual pass or a pass subscription to Jake's Deli can join a wait-list or can participate in an auction or can acquire them from another holder in a non-auction transaction, as described below.

In some examples, to purchase a pass 101 for a particular business 106, a customer 104a uses a computing device 105a, such as a desktop or laptop computer or a mobile device (e.g., a mobile phone, a tablet, a wearable computing device such as glasses or a watch, or another type of mobile device) to send a request 108 for a pass of the desired series (e.g., a pass subscription to the particular business 106) to the marketplace system 100. The computing device 105a sends the request 108 through a communications network, such as the Internet 110 or a cellular network or another type of communications network. In some examples, the customer 104a can send the request through a marketplace application 109 (also referred to as the “marketplace app”). In some examples, the customer 104 can send the request through a website associated with the marketplace system 100.

In some examples, a display module 111 can expose a listing of the types of passes that are administered by the marketplace system. The listing can be displayed in the marketplace app 109, on the website associated with the marketplace system 100, or both. The listing can include an indication of availability of each type of pass, such as whether there are any passes of a particular type available for direct purchase from the marketplace system 100.

A purchase module 112 in the marketplace system 100 receives the request 108 and determines whether a pass 101 of the desired type (we sometimes use the word “type” interchangeably with the word “series” in referring to passes) is available. For instance, the purchase module 112 accesses a pass database 114 that stores a pass record 116 for each pass 101 for each of the businesses 106. The pass record 116 can include, for each pass, a customer identifier 115 of a customer who has purchased the pass (if any) and a link to a type record 117 for the corresponding type of pass. If the pass has not been purchased, the pass record 116 can include an indicator that the pass is available. The type record 117 can include information about the type of pass, such as an identifier of the business 106, information about the pass item associated with the pass, a period price (e.g., a monthly price), a customer identifier of each customer who is on the wait-list for the pass (if any), or other information associated with the type of pass, or a combination of any two or more of them. For instance, the customer identifier 115 can be a link to a customer record 118 in a customer database 120, which can include a name of the customer, contact information for the customer (e.g., an email, a phone number, or an identifier of the customer's computing device 105), or other information associated with the customer, or a combination of any two or more of them.

If the purchase module 112 determines that a pass 101 of the desired type is available, a notification 122 is sent to the customer's computing device 105a, e.g., to the marketplace application 109 executed by the customer's mobile device. To purchase the pass, the customer uses the computing device 105a to send purchase instructions 124 to the purchase module 112. The purchase instructions 124 can include an identifier of the customer 104a, such as the customer's name, an identifier of the customer's account with the marketplace system 100, an identifier of the customer's computing device 105a, or another type of identifier, or a combination of any two or more of them. In some examples, the purchase instructions 124 can include account information, such as a credit card number, debit card number, bank account information, PayPal™ account information, or other payment information. In some examples, payment information for the customer is stored in the customer's record 118 in the customer database 120. The purchase instructions 124 can indicate the customer's authorization to charge the period price of the pass to the customer's account on an ongoing basis (e.g., to charge the monthly price of a pass subscription each month).

The customer's payment can be processed by the marketplace system 100 or by a third party payment processing system 126. Once the payment has processed, the purchase module 112 updates the pass database 114, the customer database 120, or both, such that the pass record 116 for the particular pass, the customer record 118 for the customer 104a, or both, indicate that the pass has been purchased by the customer 104a. For instance, the purchase module 112 can generate a link between the pass record 116 for the purchased pass and the customer record 118 for the customer 104a.

The purchase module 112 sends a pass token 128a to the customer 104a, e.g., to the customer's computing device 105a, e.g., as a message in the marketplace application 109. The pass token 128 includes information identifying the business 106, the pass item, the customer 104a, the period in which the pass token 128a is valid, or other information, or a combination of any two or more of them. For instance, for a monthly pass, the period in which the pass token 128a is valid is the month for which the pass is valid.

In the case where the customer 104a purchases a pass subscription, for each subsequent time period (e.g., for each month), the purchase module 112 enables the customer's account to be charged the price of the pass (e.g., the monthly price of a pass) and delivers an updated pass token to the customer 104a.

If no passes of the desired type are available, a customer can be added to a wait-list for the desired type of pass. In one example, a customer 104b uses a computing device 105b to send a request 108 for a pass to the marketplace system 100. The request 108 can be for a pass to the same business 106 as the request from the customer 104a (as shown) or for a pass to a different business. The purchase module 112 receives the request 108 and determines whether the requested type of pass is available. If the requested type of pass is not available (e.g., because all passes of that type have already been purchased), the purchase module 112 accesses the appropriate type record 117 in the pass database 114 to determine how many customers are on the wait-list for that type of pass.

The purchase module 112 sends a wait-list notification 129 to the customer 104b to inform the customer 104b of his position on the wait-list. In some examples, the customer 104b is automatically added to the wait-list for the desired type of pass. In some examples, the customer returns a confirmation 130 to the purchase module 112 to indicate that he is to be added to the wait-list. To add the customer 104b to the wait-list for a particular type of pass, the purchase module 112 updates the pass database 114, the customer database 120, or both, such that the type record 117 for the particular type of pass, the customer record 118 for the customer 104b, or both, indicate that the customer 104 is on the wait-list. For instance, the customer record 118 can be updated with a number indicative of the customer's position on the wait-list.

A wait-list module 132 monitors the wait-list for each type of pass. When a pass or pass subscription becomes available, e.g., when an owner of a pass subscription cancels the pass subscription, the wait-list module 132 identifies the first customer (e.g., customer 104b) on the wait-list and provides a notification 134 to that customer 104b. The customer 104b can then purchase the newly available pass or pass subscription through the purchase module 112, e.g., as described above.

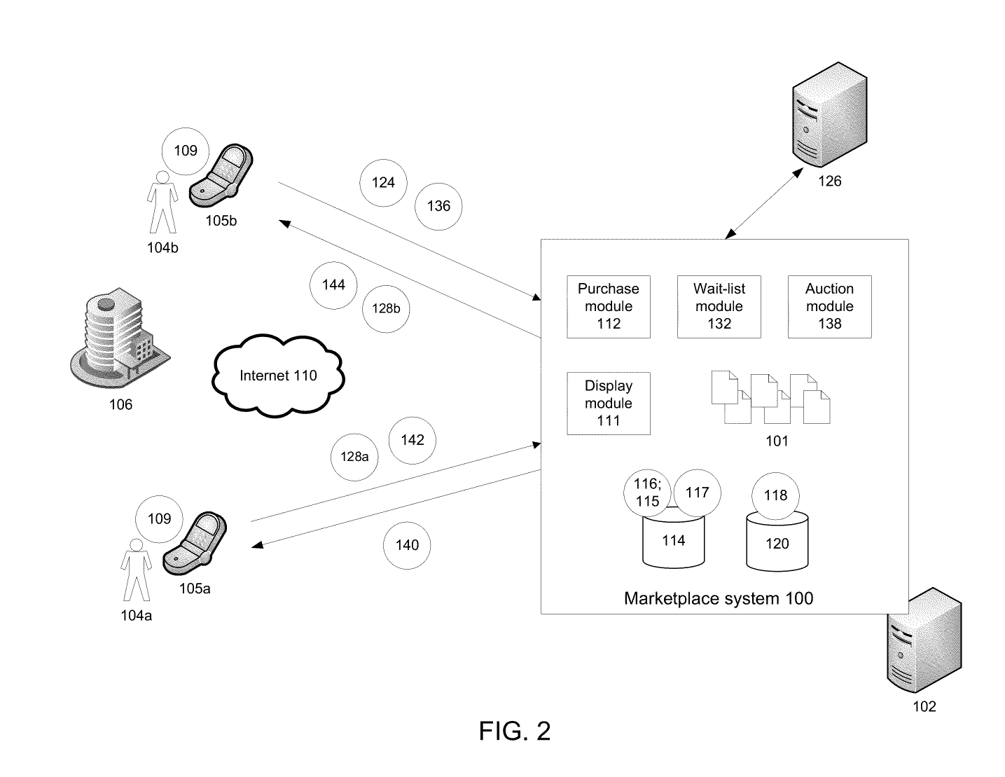

Referring to FIG. 2, in some examples, when the desired type of pass is not available, the customer 104b (whom we also refer to as the buyer) can initiate a buyer-driven auction by placing a bid to purchase a pass or pass subscription from an existing pass holder (e.g., from customer 104a). The bid price is the price that the buyer 104b is willing to pay to an existing pass holder in addition to the period price (e.g., the monthly price) of the pass in order to take over the existing pass holder's pass or pass subscription.

The buyer 104b sends a bid 136 to an auction module 138 in the marketplace system 100. The auction module 138 sends a notification 140 of the bid 136 to some or all of the existing pass holders (e.g., to customer 104a), e.g., by a text message, an email, an alert in the marketplace application, or in another manner. For instance, the notification 140 can be sent to all existing pass holders or to only those pass holders who have indicated that they are willing to consider selling a pass or pass subscription at auction.

To accept the bid 136, an existing pass holder (e.g., the customer 104a, whom we also refer to as the seller) can send an acceptance 142 to the auction module 138. The auction module 138 sends a notification 144 to notify the buyer 104b that his bid 136 was accepted. The buyer 104b sends purchase instructions 124 to the purchase module 112 to purchase the pass or pass subscription from the seller 104a and the payment is processed as described above. The bid price (in some cases less a transaction fee) is transferred to a payment account associated with the seller 104a, such as an account on the marketplace system or another online account (e.g., a PayPal™ account), a credit card, a bank account, or another type of payment account.

Once the payment has processed, the purchase module 112 updates the pass database 114, the customer database 120, or both, such that the pass record 116 for the particular pass(es), the customer records 118 for the customers 104a and 104b, or both, indicate that the pass or pass subscription has been purchased by the buyer 104b and is no longer associated with the seller 104a. For instance, the purchase module 112 can generate a link between the pass record 116 for a purchased pass and the customer record 118 for the buyer 104b and remove an existing link between the pass record 116 and the customer record 118 for the seller 118a. A pass token 128b is delivered to the buyer 104b and the pass token 128a is removed from the computing device 105a of the seller 104a.

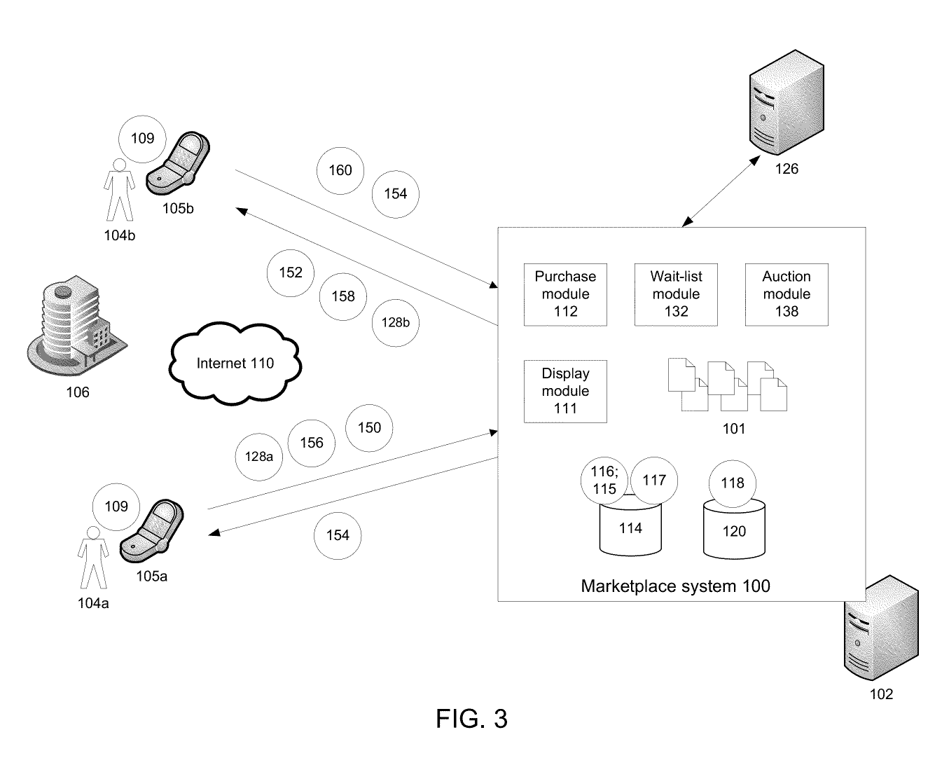

Referring to FIG. 3, in some examples, an existing pass holder (e.g., customer 104a, also referred to as the seller) can initiate a seller-driven auction to sell his pass or pass subscription to a buyer (e.g., customer 104b) on the wait-list. The seller 104a provides an auction notification 150 to the auction module 138. The auction notification 150 can indicate parameters for the auction, such as a minimum bid, an amount of time the auction will last, a list of people who can participate in the auction, or other parameters, or a combination of any two or more of them.

The auction module 138 sends a notification 152 of the auction to the customers on the wait-list (e.g., to customer 104b), e.g., by a text message, an email, an alert in the marketplace application, or in another manner. One or more of the customers on the wait-list provides a bid 154, which is the price that the buyer customer is willing to pay to the seller 104a in addition to the period price (e.g., the monthly price) of the pass in order to take over the existing pass holder's pass or pass subscription. In some examples, each customer submitting a bid 154 also provides payment information such that a temporary charge (e.g., for the amount of the bid) can be placed on each customer's account.

The auction module 138 sends the bids 154 to the seller 104a, who returns a selection 156 of one of the bids (e.g., the highest bid) as the winning bid. The auction module 138 sends a notification 158 to the buyer 104b who submitted the winning bid, who returns a confirmation 160 indicating that he still intends to purchase the seller's pass or pass subscription. The buyer's payment is processed, e.g., by finalizing the temporary charge on the buyer's payment account The bid price (in some cases less a transaction fee) is transferred to a payment account associated with the seller 104a, such as an account on the marketplace system or another online account (e.g., a PayPal™ account), a credit card, a bank account, or another type of payment account. The temporary charge on the payment account of any other buyer who submitted a bid 154 is reversed.

Once the payment has processed, the purchase module 112 updates the pass database 114, the customer database 120, or both, such that the pass record 116 for the particular pass(es), the customer records 118 for the customers 104a and 104b, or both, indicate that the pass or pass subscription has been purchased by the buyer 104b and is no longer associated with the seller 104a. A pass token 128b is delivered to the buyer 104b and the pass token 128a is removed from the computing device 105a of the seller 104a.

Referring to FIG. 4, in an example approach to facilitating a marketplace for passes, multiple passes for each of one or more businesses are purchased by the marketplace system (400). The terms of the purchase can be negotiated for each type of pass, such as the number of passes purchased, the purchase price for the multiple passes, the monthly price at which each pass can be sold to a customer, the pass item, a subscription period, or other terms, or a combination of any two or more of them. For instance, in one example, 12 months of each of 100 monthly passes for unlimited free regular coffee at Jake's Sandwich Shop can be purchased for a lump sum payment of $25,000 and sold to customers for $25 per month.

A request to purchase a particular type of pass or pass subscription (e.g., a pass to a particular business for a particular pass item) is received from a buyer (402). In some examples, a buyer can request to purchase an ongoing pass subscription, meaning that the buyer wishes to purchase a pass subscription for a monthly pass every month with no specified end date. In some examples, a buyer can request to purchase a pass for a specified number of months (e.g., one month, six months, or another number of months).

The marketplace system determines whether a pass or pass subscription is available that satisfies the buyer's request (404). If a pass or pass subscription is available (e.g., at least one of the passes purchased by the marketplace system has not been sold), the marketplace system enables the buyer to purchase the pass or pass subscription at its period price (406). In some examples, a processing fee can also be included in the price. For instance, a pass subscription for a monthly coffee pass for Jake's Sandwich Shop can be sold to the buyer for $25 per month plus an initial processing fee of $5 for the first month. Once the buyer's payment is processed (e.g., by the marketplace system or by a third party payment processing system), a pass token for the pass is delivered to the buyer (408). For instance, the pass token can be delivered to the buyer's mobile device, e.g., in an email or through a marketplace application. In some examples, e.g., if the buyer does not have a mobile device, a physical card can be provided to the buyer, e.g., through the mail or by pickup at the business. A database associated with the marketplace system is updated (410) to indicate that the pass has been purchased by the buyer. For examples in which the buyer purchases the pass for multiple months or on an ongoing basis (e.g., as a pass subscription), the buyer's payment can be processed automatically and a new pass token delivered to the customer each month (412).

If no pass or pass subscription is available (e.g., all of the passes purchased by the marketplace system have been sold), the buyer is added to a wait-list (414). In some examples, the buyer is added automatically to the wait-list; in some examples, the buyer is given the option to join the wait-list. When the buyer reaches the first position on the wait-list (416) (e.g., when all other buyers ahead of the buyer on the wait-list either purchase a pass or leave the wait-list), the buyer is offered the next available pass or pass subscription (418). For instance, a pass may become available when a pass holder's pass subscription expires or when a pass holder cancels his ongoing pass subscription. If the buyer confirms that he still wants to purchase a pass or pass subscription, the marketplace system enables the buyer to purchase the pass (406) and the pass token is delivered to the buyer (408).

If no pass or pass subscription is available, the buyer is also given the opportunity to bid for a pass or pass subscription from existing pass holders (420). To bid for a pass or pass subscription, the buyer specifies a bid price that he is willing to pay to an existing pass holder to purchase that pass holder's pass or pass subscription. The bid price is in addition to the period price (e.g., the monthly price) of the pass such that the total cost to the buyer for taking over an existing pass holder's pass or pass subscription is the bid price plus the period price of the pass.

Existing pass holders are notified of the bid (422) e.g., by a text message, an email, an alert in the marketplace application, or in another manner. In some cases, all existing pass holders who hold the desired type of pass are notified. In some cases, only existing pass holders who have indicated that they may be willing to sell their passes or pass subscriptions at auction are notified. In some cases, the bid is active for a limited period of time (e.g., one day, two days, one week, or another period of time). In some cases, the bid is active indefinitely, e.g., until the buyer retracts the bid.

If an existing pass holder accepts the bid (424), the buyer is asked to confirm that he still wants to purchase a pass or pass subscription. If so, the marketplace system enables the buyer to purchase the pass or pass subscription (406) and the pass token is delivered to the customer (408). The database is updated (410) to reflect that the ownership of the pass or pass subscription has been transferred from the previous pass holder to the buyer. The bid price (in some cases less a processing fee) is transferred to the previous pass holder, e.g., to an account on the marketplace system or another online account (e.g., a PayPal™ account), as a credit to a bank account or credit card, or to another type of payment account.

FIG. 5 shows an example approach to facilitating an auction for a pass or pass subscription offered for sale by an existing pass holder, whom we refer to here as the seller. A request to initiate an auction to sell a pass or pass subscription is received from the seller (500). The seller can specify parameters for the auction, such as a minimum bid, an amount of time the auction will last, a list of people who can participate in the auction, or other parameters, or a combination of any two or more of them. For instance, to transfer his pass or pass subscription to a particular person for free, the seller can specify a minimum bid of zero and indicate that only that particular person can participate in the auction.

Potential buyers on the wait-list are notified that a pass or pass subscription has been offered for sale (502), e.g., by a text message, an email, an alert in the marketplace application, or in another manner. A bid is received from each of one or more of the buyers (504). In some examples, each buyer provides payment account information (e.g., an account on the marketplace system or another online account (e.g., a PayPal™ account), a credit card, a bank account, or another type of payment account) along with the bid, and a temporary charge is placed on the buyer's payment account when the bid is received (506). The temporary charge can be a charge for the bid amount, for the bid amount plus the period price of the pass, or another amount.

The received bids are presented to the seller, and the seller selects one of the received bids (e.g., the highest bid) as the winning bid (508). In some examples, the auction is open for a limited amount of time (e.g., one day, two days, one week, or another amount of time), and all of the bids received during that amount of time are presented to the seller at the end of the auction. In some examples, each bid is presented to the seller as the bid is received, and the seller can select a bid whenever a bid that is acceptable to the seller is received. In some examples, the auction can be automated, e.g., such that the highest bid is automatically selected without requiring seller input. In some examples, the seller can configure parameters of the auction, such as the timing of the auction.

The buyer who submitted the winning bid is notified and asked to confirm that he still wants to purchase the pass or pass subscription (510). If so, the temporary charge on the buyer's payment account is finalized (512) and a pass token is delivered to the buyer (514). The database is updated (516) to reflect that the ownership of the pass or pass subscription has been transferred from the seller to the buyer. The bid price (in some cases less a processing fee) is transferred to the previous pass holder (518), e.g., to an account on the marketplace system or another online account (e.g., a PayPal™ account), as a credit to a bank account or credit card, or to another type of payment account. The temporary charge for each losing buyer is reversed.

FIG. 6 shows an example welcome screen 60 of the marketplace system. The welcome screen 60 includes a featured tab 61 that shows information about the featured pass types that are administered by the marketplace system. In this example, a pass 62 for unlimited free coffee at C.it Cafe is available for immediate purchase for $30 per month. Passes 64 for weekly rides from C.it Drive are administered by the marketplace system but are not available for purchase; a potential customer can join the wait-list, if desired.

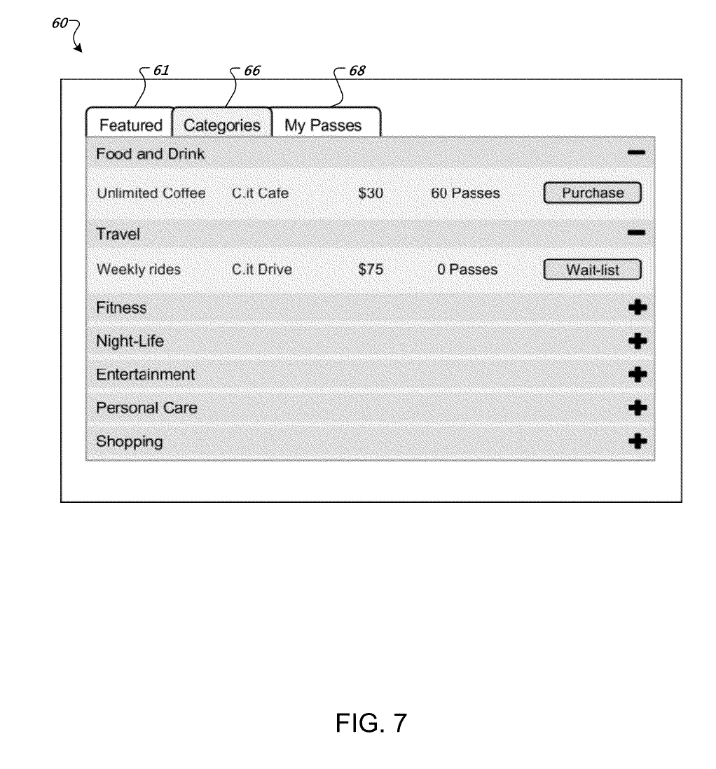

Referring to FIGS. 6 and 7, from the welcome screen 60, a user can access a categories tab 66, which shows information about some or all the pass types that are administered by the marketplace system. For instance, the pass types can be displayed by category in the categories tab 66. A search function can be available to allow a user to search by any of a variety of search parameters, such as category of the business or the pass item or both (e.g., dining, retail, services, or other categories), price, availability, or other parameters, or a combination of any two or more of them.

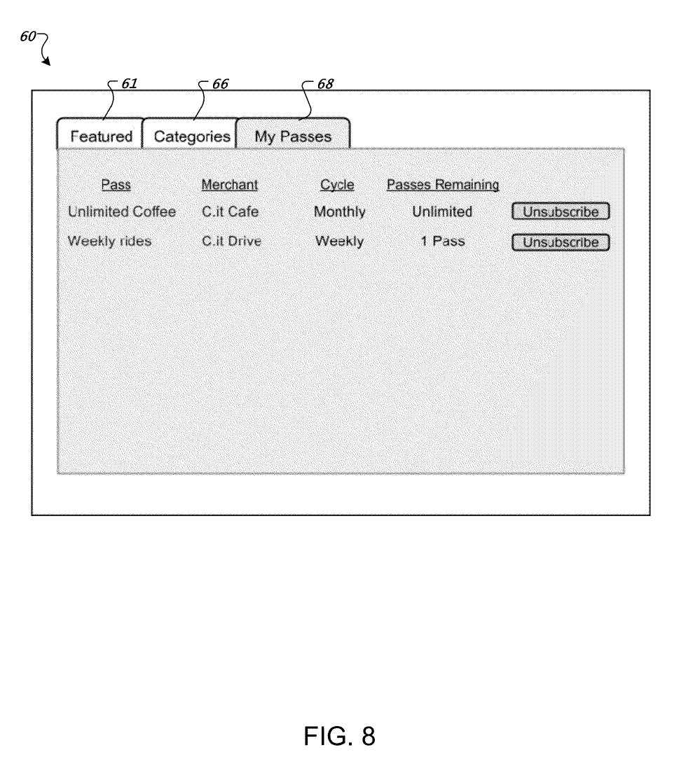

Referring to FIGS. 6 and 8, a user can also access a pass information tab 68 from the welcome screen. The pass information tab 68 can display information about the passes or pass subscription that the user has purchased or for which the user is on a wait-list. The displayed information can include, e.g., the period price (e.g., the monthly price) for each pass, details about the business associated with the pass (e.g., a name, address, hours of operation, or other details), details about the pass item associated with the pass, the user's position on the wait-list, or other information, or a combination of any two or more of them. The pass information tab 68 can also enable a user manage his passes or pass subscriptions. For instance, the user can cancel a pass or pass subscription, initiate an auction to sell a pass or pass subscription, view received bids, select a winning bid, or perform other management functions, or a combination of any two or more of them.

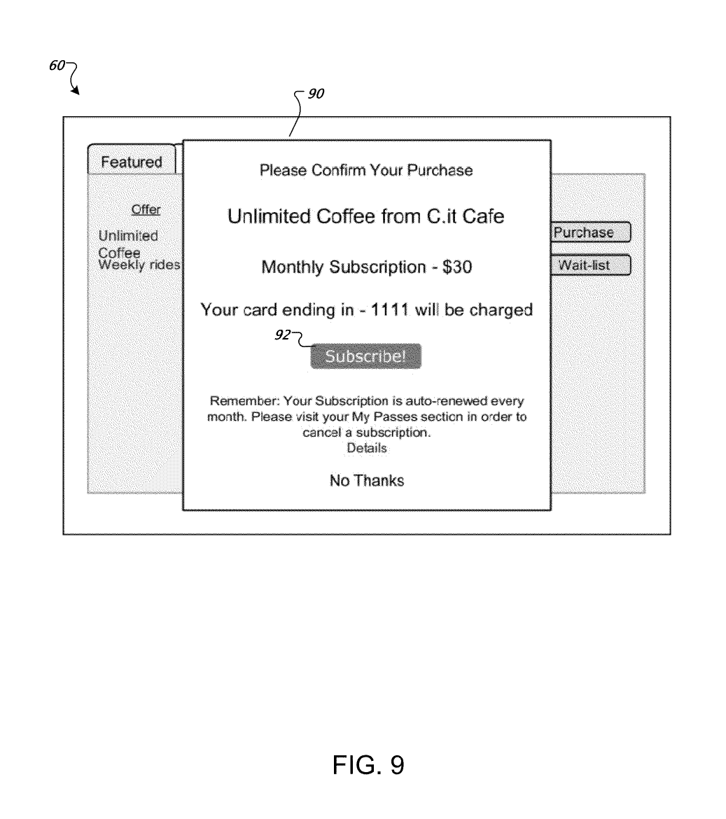

Referring to FIGS. 6 and 9, to purchase a pass or pass subscription that is available for purchase, a user selects (e.g., by clicking or tapping) a purchase button 63. A purchase confirmation window 90 is displayed that provides information about the type of the selected pass, such as the monthly price, details about the business (e.g., a name, address, hours of operation, or other details), details about the pass item associated with the selected type of pass, or other information, or a combination of any two or more of them. To complete the purchase, the user selects (e.g., by clicking or tapping) a subscribe button 92.

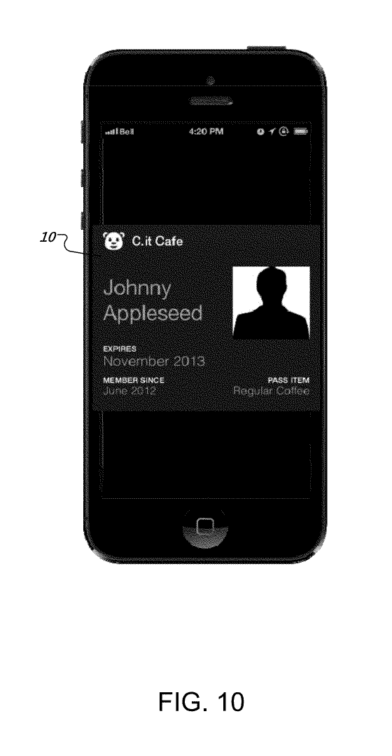

Referring to FIG. 10, a pass token 10 is delivered to the user's computing device (e.g., a mobile phone, tablet, wearable computing device, or other type of computing device), e.g., by email, text message, or directly into the marketplace app. The pass token 10 identifies the name of the business (C.it Cafe), the user's name (Johnny Appleseed), the expiration date of the pass (November 2013), the start date of the user's membership (e.g., the date when the user first purchased the C.it Cafe subscription pass), and the pass item (regular coffee). The user can show the pass token 10 to an employee (e.g., a cashier) at the business to receive the pass item.

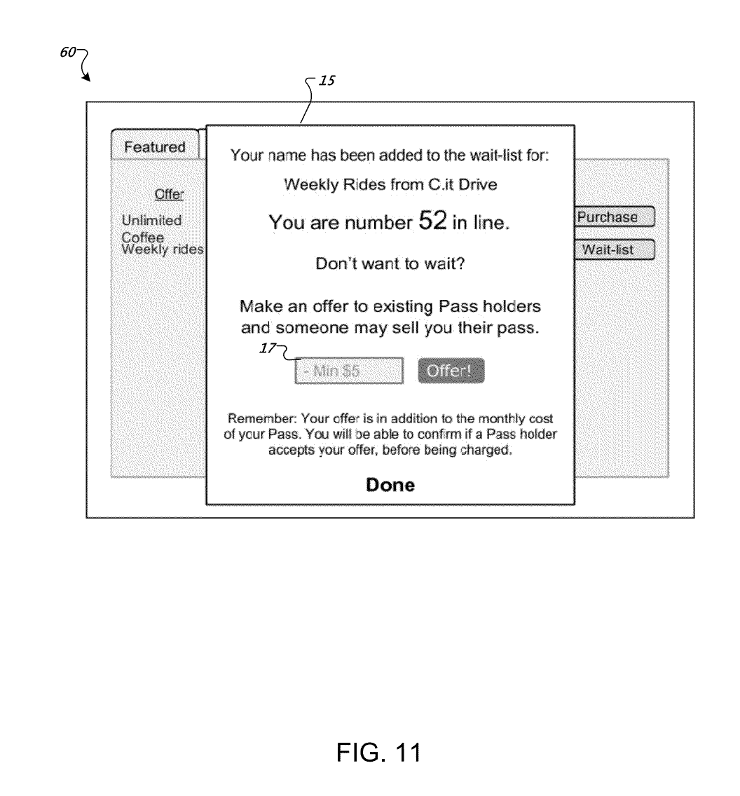

Referring to FIGS. 6 and 11, to join the wait-list for a pass or pass subscription 64, a user selects (e.g., by clicking or tapping) a wait-list button 65. A waitlist confirmation window 15 is displayed that provides information about the type of the selected pass, such as the period price (e.g., the monthly price), details about the business (e.g., a name, address, hours of operation, or other details), details about the pass item associated with the type of pass, or other information, or a combination of any two or more of them. The user's position on the wait-list is also displayed. A bid prompt 17 enables the user to specify a bid to purchase a pass or pass subscription from an existing pass holder.

FIG. 12 shows an example of a personal computing device 800 and a mobile device 850, which may be used with the techniques described here. For example, referring to FIG. 1, the computing devices 102, 105 could be examples of the personal computing device 800 or the mobile device 850. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smartphones, tablets, glasses, watches, and other similar computing devices. The components shown here, their connections and relationships, and their functions, are meant to be examples only, and are not meant to limit implementations of the techniques described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, memory on processor 802, or a propagated signal.

The high speed controller 808 manages bandwidth-intensive operations for the computing device 800, while the low speed controller 812 manages lower bandwidth-intensive operations. Such allocation of functions is an example only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provide in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provide as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, memory on processor 852, or a propagated signal that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, and so forth) and may also include sound generated by applications operating on device 850.

The computing device 850 may be implemented in a number of different forms, as shown in the figure. For example, it may be implemented as a cellular telephone 880. It may also be implemented as part of a smartphone 882, personal digital assistant, tablet computer, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Other implementations are also within the scope of the following claims.

What is claimed is:

1. A method comprising:
receiving a request for a pass of a type of pass from a first customer;
based on an availability of a pass of the requested type, enabling the first customer to purchase the pass of the requested type either (i) from a set of available passes of the requested type or (ii) from a second customer; and
enabling a mobile device associated with the first customer to be used to present the purchased pass.

2. The method of claim 1, comprising determining the availability of the pass of the requested type.

3. The method of claim 2, in which determining the availability of the pass of the requested type comprises determining how many of the requested type of passes have been purchased.

4. The method of claim 1, comprising enabling the first customer to purchase a pass when at least one pass of the requested type is available.

5. The method of claim 1, comprising enabling the first customer to purchase a pass from a second customer when no pass of the requested type is available.

6. The method of claim 1, in which enabling the first customer to purchase a pass from the second customer comprises receiving a bid from the first customer for the pass.

7. The method of claim 6, in which enabling the first customer to purchase the pass from the second customer comprises:
providing a notification of the bid to one or more second customers; and
receiving an acceptance from one of the second customers.

8. The method of claim 6, comprising prompting the first customer to provide a bid for the pass.

9. The method of claim 6, in which enabling the first customer to purchase the pass from the second customer comprises:
notifying the first customer that the second customer is selling a pass of the requested type; and
receiving the bid responsive to the notifying.

10. The method of claim 9, comprising receiving an offer to sell the pass from the second customer.

11. The method of claim 1, associating the first customer with a wait-list for the requested type of pass if the requested type of pass is not available.

12. The method of claim 11, comprising enabling the first customer to purchase a pass from a set of available passes of the requested type based on the availability of a pass of the requested type and a position of the first customer on the wait-list.

13. The method of claim 11, comprising updating a position of the first customer on the wait-list based on a purchase of a pass of the requested type by a third customer.

14. The method of claim 1, in which enabling the mobile device to be used to present the purchased pass comprises providing a pass token associated with the purchased pass to the mobile device.

15. The method of claim 14, in which providing the purchased pass to the mobile device includes providing at least one of an identifier of a business associated with the pass, an identifier of a pass item associated with the pass, a date associated with the pass, and an identifier of the first customer.

16. A computer readable storage medium storing instructions for causing a computing system to:
receive a request for a pass of a type of pass from a first customer;
based on an availability of a pass of the requested type, enable the first customer to purchase the pass of the requested type either (i) from a set of available passes of the requested type or (ii) from a second customer; and
enable a mobile device associated with the first customer to be used to present the purchased pass.

17. A method comprising:
receiving a notification of an opportunity to purchase a pass of a requested type of pass either (i) from a set of available passes of the requested type, or (ii) from a customer;
sending instructions to purchase the pass of the requested type; and
receiving data associated with the purchased pass.

18. The method of claim 17, comprising sending a request for the pass of the requested type.

19. The method of claim 17, in which sending instructions to purchase the pass comprises specifying a bid amount.

20. The method of claim 17, in which the data associated with the purchased pass comprises one or more of an identifier of a business associated with the pass, an identifier of a pass item associated with the pass, a date associated with the pass, and an identifier of the purchaser of the pass

21. A method comprising:
displaying to a business, on a display interface of a mobile device, data indicative of a pass item associated with a purchased pass of a particular type,
the pass purchased either (i) from a set of available passes of the particular type, or (ii) from a customer.
